(19) United States
(12) Patent Application Publication
(10) Pub. No.: US 2015/0193110 A1
(43) Pub. Date: Jul. 9, 2015

(54) OBJECT STOP POSITION CONTROL METHOD, OPERATION DISPLAY DEVICE AND NON-TRANSITORY COMPUTER-READABLE RECORDING MEDIUM

(71) Applicant: KONICA MINOLTA, INC., Chiyoda-ku (JP)

(72) Inventor: Masao TAKAHASHI, Fuchu-shi (JP)

(73) Assignee: KONICA MINOLTA, INC., Tokyo (JP)

(21) Appl. No.: 14/587,471

(22) Filed: Dec. 31, 2014

(30) Foreign Application Priority Data
Jan. 6, 2014 (JP) 2014-000624

(51) Int. Cl. G06F 3/0486

(52) U.S. Cl. CPC G06F 3/0486

(57) ABSTRACT

Disclosed is an object stop position control method, including: moving an object displayed on a display unit in accordance with a movement instruction for moving the object, in case that the movement instruction is received from a user; and stopping a movement of the object, which is carried out in accordance with the movement instruction, to stop the object at a predetermined stop position, in case that it is judged that the object passes the predetermined stop position in the movement of the object.

### BACKGROUND OF THE INVENTION

1. Field of the Invention

The present invention relates to an object stop position control method, an operation display device and a non-transitory computer-readable recording medium for controlling the stop position of the object when the object is moved on a display window in accordance with the movement instruction from the user.

2. Description of Related Art

In various types of apparatuses, such as a PC (Personal Computer), a tablet, a multi-function peripheral and the like, the user I/F (Interface) for receiving the movement instruction for moving the object (a figure, a slide bar, or the like) displayed on the display unit from a user via a mouse which is a pointing device, a touch panel or the like, to move the object on the window in accordance with the movement instruction, has been often adopted.

In case that the object is moved, a user requests that the object is precisely stopped at a specific stop position by a simple operation. For example, in case of the slide bar for adjusting the sound volume balance between the right speaker and the left speaker for outputting a stereo sound, the user requests that the slider is easily stopped at the center position. Further, in case of the figure, the user requests that the figure is arranged at a grid.

As a function for satisfying the above request, the snap function for moving the object so as to attract the object to a specific stop position when the object approaches the specific stop position within a predetermined distance from the specific stop position, has been adopted.

However, when the snap function is used, even though the user attempts to stop the object at the position which is slightly apart from the specific stop position, the object is attracted to the specific stop position. Therefore, the object cannot be stopped at the position which is slightly apart from the specific stop position.

In Japanese Patent Application Publication No. 2006-189989, the following object editing method is disclosed. In the snap function for attracting the side of the object to the grid, by changing the side to be attracted to the grid according to the direction in which the figure is moved by using a mouse or the like, the object is prevented from being unnecessarily attracted.

In accordance with the method disclosed in Japanese Patent Application Publication No. 2006-189989, although the snap position is changed by changing the movement direction, one of the sides of the figure is necessarily attracted. Therefore, it is not possible to eliminate the possibility that the stop position of the object is changed against the user's intention. Further, in case that the interval of the snap positions is shorter than the attraction distance, the object is attracted to one of the snap positions. Therefore, the object cannot be arranged at the position except the snap position.

In order to solve the above problem, for example, in case that the snap function interferes with the movement instruction, the snap function is switched off. However, the frequent operations for switching on/off the snap function are a troublesome task, and the operability of the operation display device is deteriorated. Alternatively, when the attraction distance is shortened, the object can be more freely stopped at the position which is intended by the user. However, because it is difficult to operate the snap function, the operation for stopping the object at the specific stop position becomes complicated.

### SUMMARY

To achieve at least one of the abovementioned objects, an object stop position control method reflecting one aspect of the present invention comprises:

moving an object displayed on a display unit in accordance with a movement instruction for moving the object, in case that the movement instruction is received from a user; and

stopping a movement of the object, which is carried out in accordance with the movement instruction, to stop the object at a predetermined stop position, in case that it is judged that the object passes the predetermined stop position in the movement of the object.

Preferably, in the movement of the object, which is carried out in accordance with the movement instruction, the object is moved only while the movement instruction is received from the user.

Preferably, in case that the movement instruction is continued above a certain degree after the object is stopped at the predetermined stop position, the movement of the object is restarted in accordance with the movement instruction.

Preferably, a touch panel is provided on a display surface of the display unit,

the movement instruction is a touch operation in which after the touch panel is touched with a contact body at a display position of the object, a touch position of the contact body is moved while the touch panel is touched with the contact body,

in the movement of the object, which is carried out in accordance with the movement instruction, while the contact body touches the touch panel, the object is moved so as to follow the touch position of the contact body, and when the contact body is released from the touch panel, the object is stopped, and

in case that it is judged that the touch position of the contact body passes the predetermined stop position, the movement of the object, which is carried out in accordance with the movement instruction, is stopped to stop the object at the predetermined stop position.

Preferably, in case that after the object is stopped at the predetermined position, the touch operation is continued and the touch position is apart from the predetermined stop position by a predetermined distance, the movement of the object is restarted in accordance with the movement instruction.

Preferably, the movement instruction is an instruction for inertially moving the object after the movement instruction is ended, and

when the object which is inertially moved passes the predetermined stop position, the movement of the object, which is carried out in accordance with the movement instruction, is stopped to stop the object at the predetermined stop position.

Preferably, a touch panel is provided on a display surface of the display unit,

the movement instruction is a flick operation in which after the touch panel is touched with a contact body at a display position of the object, the contact body is released from the touch panel so as to flick the object, and

in the movement of the object, which is carried out in accordance with the movement instruction, while the contact body touches the object, the object is moved so as to follow a touch position of the contact body, and after the contact body is released from the touch panel so as to flick the object, the object is inertially moved.

Preferably, the predetermined stop position can be changed.

### BRIEF DESCRIPTION OF THE DRAWINGS

The present invention will become more fully understood from the detailed description given hereinafter and the accompanying drawings given by way of illustration only, and thus are not intended as a definition of the limits of the present invention, and wherein:

FIG. 1 is a block diagram showing the schematic configuration of the operation display device according to the embodiment;

FIGS. 2A to 2C are views for explaining the slide bar displayed on the display unit of the operation display device and the movement of the slider;

FIG. 3 is a flowchart showing the process to be carried out in every event on the touch panel of the operation display device;

FIGS. 4A to 4C are views showing an example in which the object can be moved in two-dimension;

FIGS. 5A to 5C are views showing an example in which each grid line of the lattice formed in a matrix shape is set to the specific stop position;

FIGS. 6A to 6C are views showing the situation in which the slider (ball) of the slide bar is moved from left to right by the flick operation;

FIG. 7 is a flowchart showing the process to be carried out in every event on the touch panel by the operation display device which receives the movement instruction by the flick operation;

FIG. 8 is a flowchart showing the inertia periodic timer process;

FIGS. 9A to 9C are views showing the movement example in which the touch operation is continued by using the user's finger after the object (slider) is stopped at the specific stop position;

FIG. 10 is a flowchart showing the process for carrying out the focus again in case that the operation for carrying out the movement instruction is continued after the object is stopped at the specific stop position; and

FIG. 11 is a view showing an example of the slide bar for setting the copy magnification of the multi-function peripheral.

### DETAILED DESCRIPTION OF PREFERRED EMBODIMENT

Hereinafter, a preferred embodiment of the present invention will be explained with reference to the accompanying drawings.

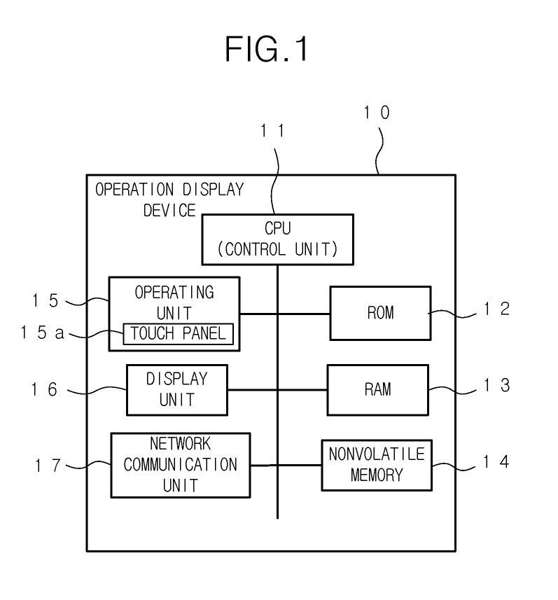

FIG. 1 is a block diagram showing the schematic configuration of the operation display device 10 according to the embodiment. The operation display device 10 comprises a CPU (Central Processing Unit) 11 for entirely controlling the operation of the operation display device 10. The CPU 11 is connected with a ROM (Read Only Memory) 12, a RAM (Random Access Memory) 13, a nonvolatile memory 14, an operating unit 15, a display unit 16 and a network communication unit 17 via a bus.

By the CPU 11, a middleware, application programs and the like are executed on an OS (Operating System) program as a base. Further, the CPU 11 functions as the control unit for controlling the display of the object on the display unit 16.

In the ROM 12, various types of programs are stored. By executing various types of processes by the CPU 11 in accordance with these programs, each function of the operation display device 10 is realized.

The RAM 13 is used as a work memory for temporarily storing various types of data when the CPU 11 carries out the process in accordance with the programs, and for storing display data.

The nonvolatile memory 14 is a memory (flash memory) in which the stored contents are not damaged even if the operation display device 10 is turned off, and is used for storing various setting information, and the like.

The display unit 16 comprises a liquid crystal display and the like, and has the function for displaying optional display contents. The operating unit 15 has the function for receiving the movement instruction for moving the object displayed on the display unit 16 from the user, in addition to the operation, such as the input of the job or the like. The operating unit 15 comprises hardware keys and a touch panel 15a having the tabular form and provided on the display screen of the display unit 16. The touch panel 15a detects the coordinate position on which the touch panel 15a is pushed by using the contact body, such as a touch pen, the user's finger or the like, and a flick operation, a drag operation and the like. The detecting method used in the touch panel 15a may be an optional method, such as a method in which the coordinate position and the like are detected by using capacitors, an analog/digital resistive film, infrared light, ultrasonic waves, electromagnetic induction, or the like. Hereinafter, in this embodiment, the user's finger is used as the contact body.

The network communication unit 17 has the function for communicating data with a multi-function peripheral or other external devices via a network, such as a LAN (Local Area Network) or the like.

For example, the operation display device 10 is a remote operation panel of a tablet terminal or a multi-function peripheral, an operation panel provided in the main body of a multi-function peripheral, or the like. The multi-function peripheral is an apparatus having a copy function for optically reading an original to print an image on a recording sheet, a scan function for obtaining image data by reading an original to store the image data as a file and/or to transmit the image data to an external terminal via the network, a printer function for printing out an image based on the print data received from an external PC or the like via the network by forming the image on the recording sheet, a facsimile function for transmitting and receiving the image data in compliance with the facsimile protocol, and the like.

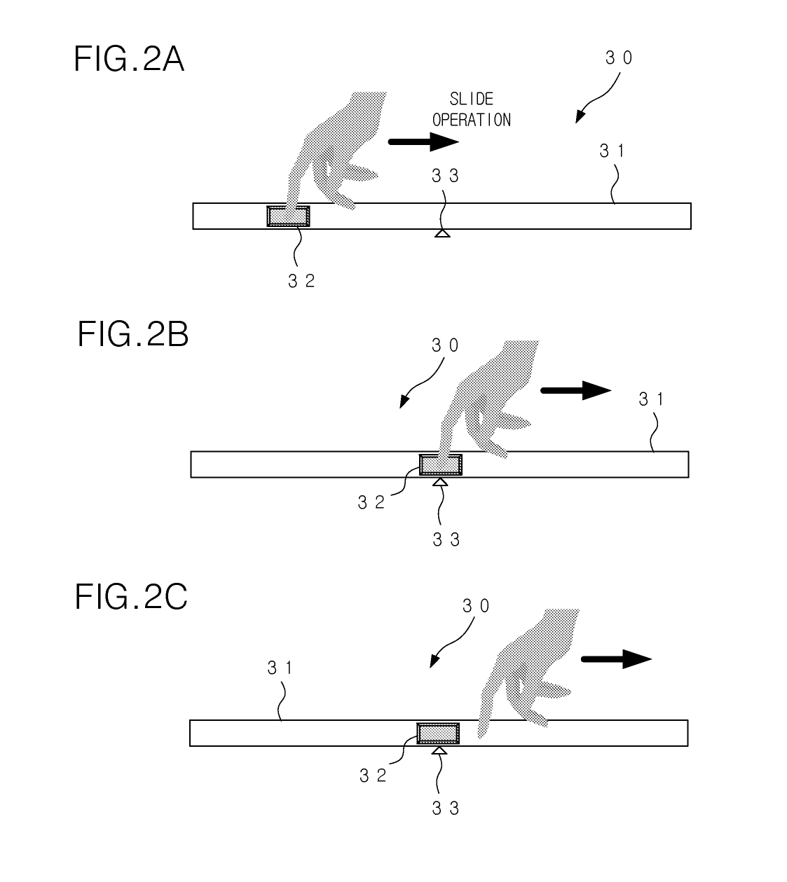

FIGS. 2A to 2C are views for explaining the slide bar 30 displayed on the display unit 16 of the operation display device 10 and the movement of the slider 32. The slide bar 30 comprises a scale portion 31 which simulatedly shows the linear channel having a predetermined length, and the slider 32 which moves in the scale portion 31. The slider 32 is the object to be moved in accordance with the movement instruction.

The slider bar 30 is a user I/F for adjusting an optional control parameter (for example, the density of the copy). With respect to the value of the control parameter, for example, the left end of the scale portion 31 corresponds to the minimum value of the control parameter. The value of the control parameter increases as the slider 32 moves toward the right end of the scale portion 31, and the right end of the scale portion 31 corresponds to the maximum value of the control parameter. The value corresponding to the current position of the slider 32 in the scale portion 31 is the current value of the control parameter.

In this example, the specific stop position 33 (predetermined stop position) is previously set to the middle position in the longitudinal direction of the scale portion 31. When the slider 32 is positioned on the specific stop position 33, the control parameter has the middle value of the area in which the value can be adjusted by using the slide bar.

When the movement instruction for moving the slider 32 of the slide bar 30 displayed on the display unit 16 is received from the user, the CPU 11 of the operation display device 10 moves the slider 32 in accordance with the movement instruction.

In this example, the movement instruction is an operation in which after the user touches the touch panel 15a on the display position of the slider 32 with the user's finger, the user moves the touch position while the user touches the touch panel 15a with the user's finger. After the user touches the slider 32 with the user's finger, the user can move the slider 32 on the scale portion 31 by moving the user's finger along the scale portion 31 while the user touches the touch panel 15a.

While the user's finger touches the touch panel 15a in the above movement instruction, the CPU 11 of the operation display device 10 moves the slider 32 on the scale portion 31 so as to follow the user's finger which touches the touch panel 15a. Then, when the user's finger is released from the touch panel 15a, the CPU 11 stops the slider 32 at the position on which the user's finger is released from the touch panel 15a. However, when the CPU 11 judges that the slider 32 (this is, the touch position) passes the specific stop position 33 in the movement of the slider 32 in accordance with the movement instruction, the CPU 11 stops the movement of the slider 32, which is carried out in accordance with the movement instruction, and stops the slider 32 at the specific stop position 33.

FIGS. 2A to 2C show the situation in which the user touches the slider 32 with the user's finger and moves the slider 32 from the left to the right. FIG. 2A shows the situation in which the movement of the slider 32 is started by touching the touch panel 15a. The slider 32 is moved so as to follow the user's finger. FIG. 2B shows the situation in which the slider 32 reaches the specific stop position 33. FIG. 2C shows the situation in which the slider 32 is automatically stopped at the specific stop position 33 because the touch position passes the specific stop position 33. The slider 32 is stopped at the specific stop position 33 even though the user moves the user's finger. Therefore, the user has a feeling that the slider 32 is left at the specific stop position 33.

As described above, the user can precisely stop the slider 32 at the specific stop position 33 which has been previously set, by carrying out the operation for moving the slider 32 along the scale portion 31 so as to pass the specific stop position 33. Further, in case that the slider 32 approaches the specific stop position 33 from an optional direction so as not to pass the specific stop position 33 and the user's finger is released from the slider 32, the slider 32 can be stopped close to the specific stop position 33 in the optional direction with respect to the specific stop position 33.

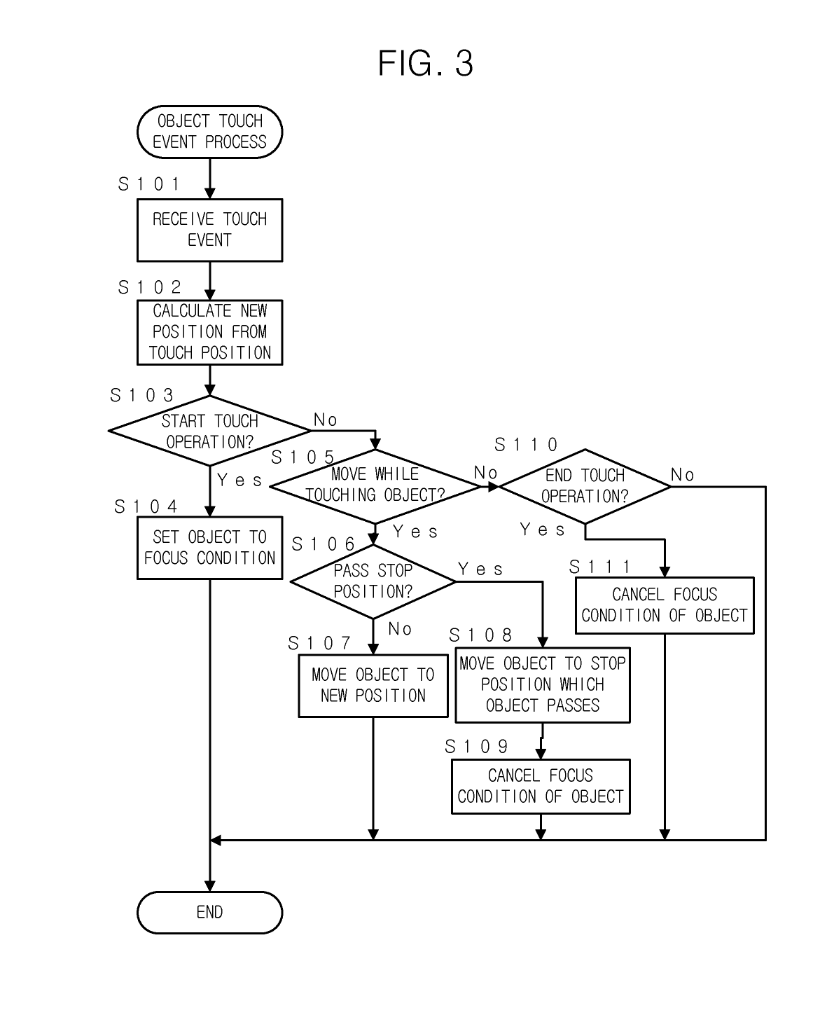

FIG. 3 is a flowchart showing the process to be carried out by the operation display device 10. The process is carried out every when any event is received via the touch panel 15a. For example, the touch panel 15a detects the touch position of the user's finger at a predetermined sampling period (for example, 50 ms) and the CPU 11 generates the event every when the touch position is detected.

When the event is received via the touch panel 15a (Step S101), the CPU 11 calculates a new touch position of the user's finger from the touch position indicated in the event (the touch position at the time of the generation of the event) (Step S102).

In case that the event which is received at present is the event in which the touch operation is started (the event indicating that the user's finger newly touches the touch panel 15a) (Step S103; Yes), the CPU 11 sets the object to the focus condition (Step S104). Then, the process is ended. The focus condition is the condition in which the object is moved so as to follow the user's finger which touches the touch panel 15a. When the object is in the focus condition, the object receives the subsequent touch events.

In case that the event which is received at present is the event indicating that the user's finger moves while the finger touches the touch panel 15a (Step S105; Yes), the CPU 11 judges whether the touch position passes the specific stop position in the movement of the object (Step S106). That is, the CPU 11 judges whether the specific stop position is positioned between the display position of the object and the new touch position.

In case that the object does not pass the specific stop position (Step S106; No), the CPU 11 moves the object to the new touch position (Step S107). Then, the process is ended. Thereby, the object is moved so as to follow the user's finger.

In case that the object passes the specific stop position (Step S106; Yes), the CPU 11 moves the display position of the object to the specific stop position which the object passes (Step S108). The CPU 11 cancels the focus condition of the object (Step S109). Then, the process is ended. When the focus condition is cancelled, the object does not receive the subsequent events. Thereby, the object is stopped and displayed at the specific stop position and does not follow the user's finger.

In case that the event which is received at present is the event in which the touch operation is ended (the event indicating that the user's finger is released from the touch panel 15a) (Step S110; Yes), the CPU 11 cancels the focus condition of the object (Step S111). Then, the process is ended. Thereby, the object is stopped at the touch position shortly before the finger is released from the touch panel 15a.

FIGS. 2A to 2C show the case in which the object (slider 32) is moved in one-dimension. However, the object may be moved in two-dimension.

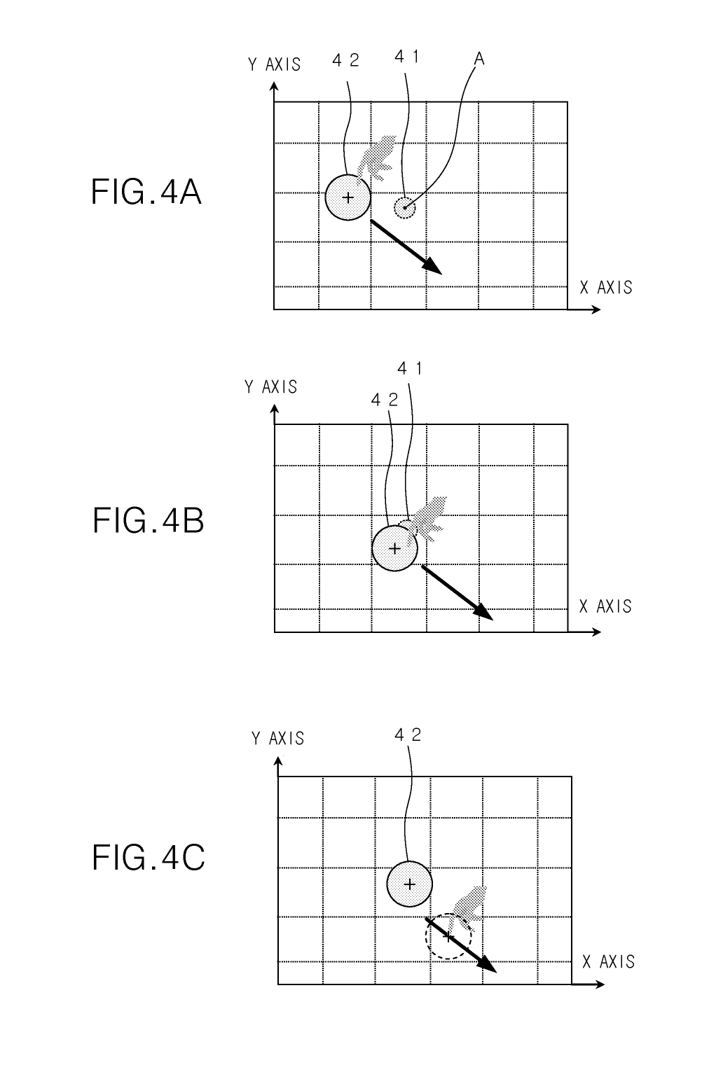

FIGS. 4A to 4C show the case in which the object can be moved in two-dimension. FIG. 4A shows the situation in which the object 42 to be moved is moved by touching the object 42 with the user's finger. In case that the specific stop position is the point A, the predetermined circle having the point A as the center is set to the passing judgment area 41.

When the object 42 which is moved in accordance with the movement instruction from the user (or the touch position) passes through the passing judgment area 41 (See FIG. 4B), the CPU 11 judges that the object 42 (or the touch position) passes the specific stop position and stops the object 42 at the point A which is the specific stop position (See FIG. 4C). In FIG. 4C, the position of the object 42 which might be moved in case that the object 42 continues to follow the user's finger is shown by the dashed line.

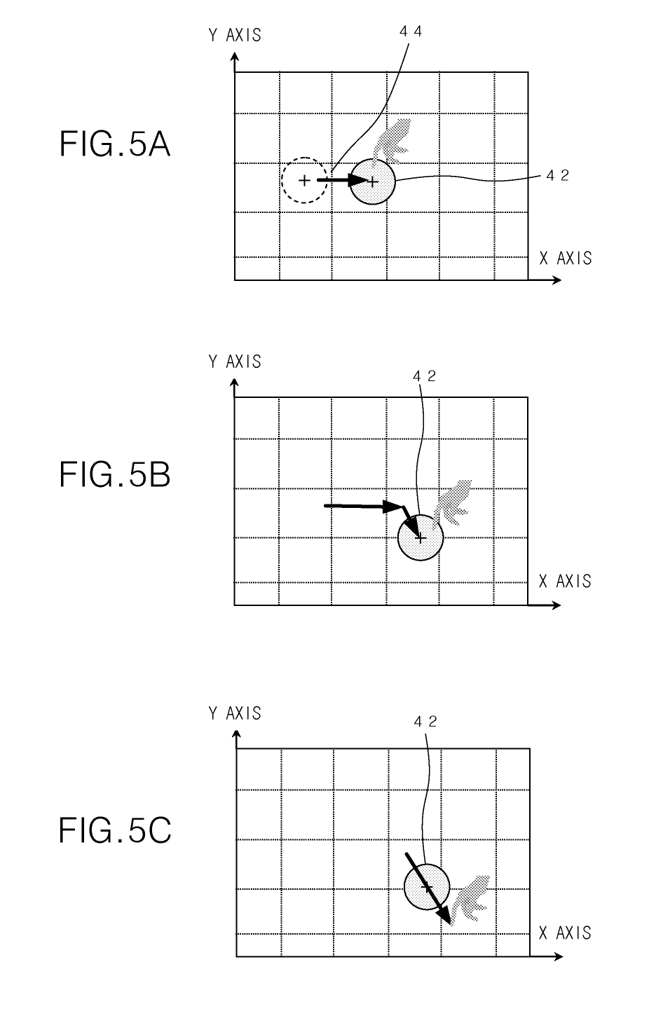

FIGS. 5A to 5C show an example in which each grid line of the lattice formed in a matrix shape is set to the specific stop position. Both of each grid line in X direction and each grid line in Y direction can be set to the specific stop position. Alternatively, only one of each grid line in X direction and each grid line in Y direction can be set to the specific stop position.

FIGS. 5A to 5C show an example in which only each grid line in X direction is set to the specific stop position. In accordance with the movement instruction from the user (by following the user's finger), the object 42 is moved. In this movement, even thought the object 42 (or the touch position) passes the grid line 44 in Y direction, the object 42 is not stopped (FIG. 5A).

When the object 42 which is moved in accordance with the movement instruction from the user (or the touch position) passes the grid line in X direction (FIG. 5B), the object 42 is stopped at the passing position on the grid line and is displayed. FIG. 5C shows the situation in which the object 42 is stopped on the grid line in X direction even though the user's finger continues to move while the user's finger touches the object 42.

Next, the case in which the movement instruction is the flick operation in which after the user's finger touches the touch panel 15a at the display position of the object, the finger is released from the touch panel 15a so as to flick the object, will be explained.

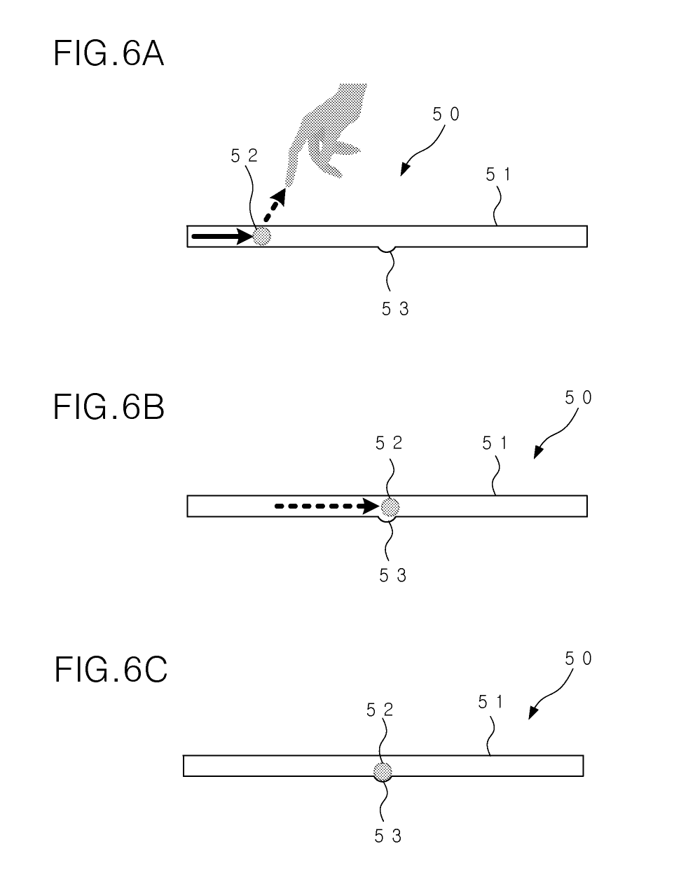

FIGS. 6A to 6C are views for explaining the slide bar 50 displayed on the display unit 16 of the operation display device 10 and the movement of the slider. The slide bar 50 comprises a scale portion 51 which simulatedly shows the linear channel having a predetermined length, and the ball 52 which moves in the scale portion 51. The ball 52 is the object to be moved in accordance with the movement instruction.

The slide bar 50 is a user I/F for adjusting an optional control parameter (for example, the density of the copy). With respect to the value of the control parameter, for example, the left end of the scale portion 51 corresponds to the minimum value of the control parameter. The value of the control parameter increases as the ball 52 moves toward the right end of the scale portion 51, and the right end of the scale portion 51 corresponds to the maximum value of the control parameter. The value corresponding to the current position of the ball 52 in the scale portion 51 is the current value of the control parameter.

In this example, the specific stop position 53 is previously set to the middle position in the longitudinal direction of the scale portion 51. On the specific stop position 53, the depression for fitting the ball 52 is displayed. By displaying the depression at the specific stop position 53, the user can intuitively recognize that the ball 52 is stopped by fitting the ball 52 with the depression.

When the movement instruction for moving the ball 52 of the slide bar 50 displayed on the display unit 16 is received from the user, the CPU 11 of the operation display device 10 moves the ball 52 in accordance with the movement instruction.

In this example, the movement instruction is the flick operation in which after the user's finger touches the touch panel 15a at the display position of the ball 52, the finger is released from the touch panel 15a so as to flick the ball 52. The finger may move before the ball 52 is flicked. When the user flicks the ball 52 with the user's finger, the ball 52 moves inertially after the finger is released from the touch panel 15a. Then, the ball 52 is stopped.

While the user's finger touches the touch panel 15a in the movement instruction which is carried out by the above flick operation, the CPU 11 of the operation display device 10 moves the ball 52 on the scale portion 51 so as to follow the user's finger which touches the touch panel 15a. Then, when the user's finger is released from the touch panel 15a so as to flick the ball 52, the CPU 11 moves the ball 52 inertially.

However, in case that the CPU 11 judges that the ball 52 passes the specific stop position 53 in the movement of the ball 52 in accordance with the movement instruction, the CPU 11 stops the movement of the ball 52 (the movement in which the ball 52 is inertially moved), which is carried out in accordance with the movement instruction, and stops the ball 52 at the specific stop position 53.

FIGS. 6A to 6C show the situation in which the ball 52 is moved from left to right by the flick operation. FIG. 6A shows the situation in which after the ball 52 is slightly moved by touching the ball 52, the flick operation is carried out. FIG. 6B shows the situation in which the ball 52 which is inertially moved passes the specific stop position 53 (depression). FIG. 6C shows the situation in which the ball 52 is automatically stopped by fitting the ball 52 with the depression at the specific stop position 53.

As described above, the user can precisely stop the ball 52 at the specific stop position 53 which is previously set, by flicking the ball 52 in the flick operation so as to pass the specific stop position 53.

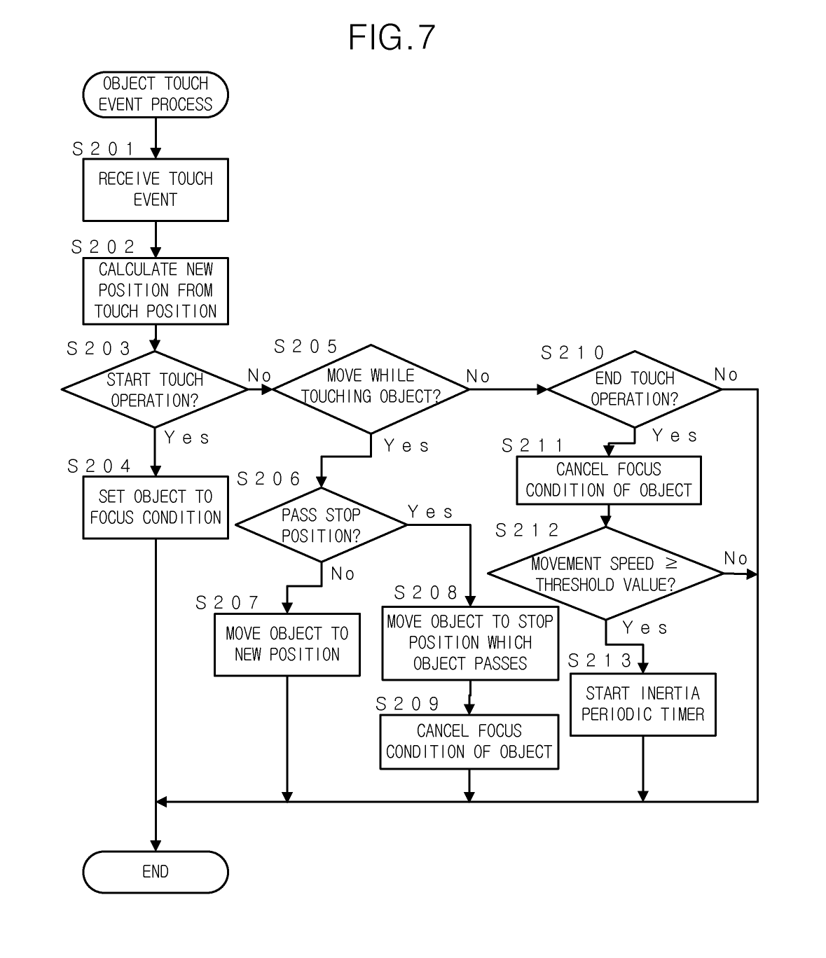

FIG. 7 shows the flowchart of the process to be carried out by the operation display device 10 which receives the movement instruction by the flick operation. Like the process shown in FIG. 3, the process is carried out every when any event is received via the touch panel 15a.

When the event is received via the touch panel 15a (Step S201), the CPU 11 calculates a new touch position of the user's finger from the touch position indicated in the event (the touch position at the time of the generation of the event) (Step S202).

In case that the event which is received at present is the event in which the touch operation is started (Step S203; Yes), the CPU 11 sets the object to the focus condition (Step S204). Then, the process is ended. The focus condition is the condition in which the object is moved so as to follow the user's finger which touches the touch panel 15a. When the object is in the focus condition, the object receives the subsequent touch events.

In case that the event which is received at present is the event indicating that the user's finger moves while the finger touches the touch panel 15a (Step S205; Yes), the CPU 11 judges whether the touch position passes the specific stop position in the movement of the object (Step S206). That is, the CPU 11 judges whether the specific stop position is positioned between the display position of the object and the new touch position.

In case that the object does not pass the specific stop position (Step S206; No), the CPU 11 moves the object to the new touch position (Step S207). Then, the process is ended. Thereby, the object is moved so as to follow the user's finger.

In case that the object passes the specific stop position (Step S206; Yes), the CPU 11 moves the display position of the object to the specific stop position which the object passes (Step S208). The CPU 11 cancels the focus condition of the object (Step S209). Then, the process is ended. When the focus condition is cancelled, the object does not receive the subsequent events. Thereby, the object is stopped and displayed at the specific stop position and does not follow the user's finger.

In case that the event which is received at present is the event in which the touch operation is ended (the event indicating that the user's finger is released from the touch panel 15a) (Step S210; Yes), the CPU 11 cancels the focus condition of the object (Step S211). Then, the CPU 11 judges whether the movement speed of the object is equal to or more than the threshold value (Step S212). The movement speed of the object is set to the speed corresponding to the flick speed at which the user flicks the object when the touch operation is ended.

In case that the movement speed of the object is less than the threshold value (Step S212; No), the process is ended. In this case, because the user releases the user's finger from the touch panel 15a without flicking the object, the object is stopped and displayed at the touch position shortly before the finger is released from the touch panel 15a.

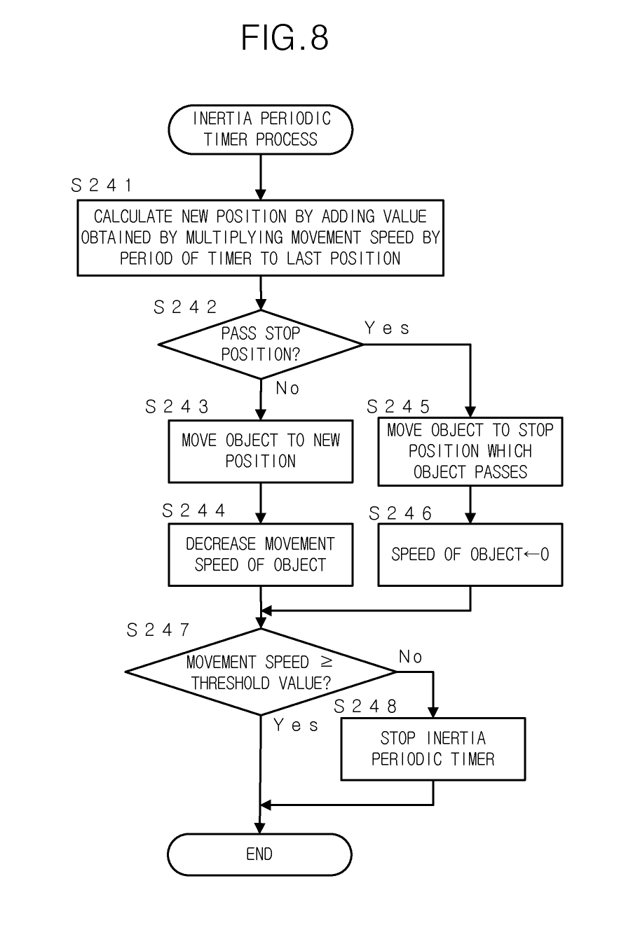

In case that the movement speed of the object is equal to or more than the threshold value (Step S212; Yes), the CPU 11 starts the inertia periodic timer (Step S213). Then, the process is ended. The inertia periodic timer generates the timer event at the predetermined period. Every when the timer event is generated, the inertia periodic timer process shown in FIG. 8 is carried out. The inertia periodic timer process is the process for inertially moving the object when the object is flicked with the user's finger.

FIG. 8 is the flowchart showing the detail of the inertia periodic timer process. When the timer event is generated, the CPU 11 multiplies the current movement speed of the object by the period of the timer to calculate the movement distance of the object in the period of the timer. Further, the CPU 11 calculates the new display position of the object by adding the calculated movement distance to the last display position of the object (Step S241).

Next, the CPU 11 judges whether the object passes the specific stop position (Step S242). That is, the CPU 11 judges whether the specific stop position is positioned between the last display position of the object and the new display position of the object.

In case that the object does not pass the specific stop position (Step S242; No), the CPU 11 moves the object to the new display position (Step S243) and decreases the movement speed of the object (Step S244).

The CPU 11 judges whether the movement speed of the object is equal to or more than the threshold value (Step S247). In case that the movement speed is equal to or more than the threshold value (Step S247; Yes), the process is ended. In case that the movement speed is less than the threshold value (Step S247; No), the CPU 11 stops the inertia periodic timer (Step S248). Then, the process is ended.

In case that the object passes the specific stop position (Step S242; Yes), the CPU 11 moves the display position of the object to the specific stop position which the object passes (Step S245). Then, the CPU 11 sets the movement speed of the object to 0 (Step S246), and the process proceeds to Step S247. In this case, because the movement speed of the object is less than the threshold value, the process proceeds to “No” in Step S247. Then, the CPU 11 stops the inertia periodic timer (Step S248), and the process is ended.

Next, the case in which when the operation display device 10 continues to receive the movement instruction from the user above a certain degree after the object is stopped at the specific stop position, the movement of the object is restarted in accordance with the movement instruction, will be explained.

In case that there are a plurality of specific stop positions on the path along which the user moves the object to an intended position, every when the object passes the specific stop position, the focus condition is cancelled. Because it is required to retouch the object, the convenience of the operation display device 10 is deteriorated. Therefore, in case that the operation display device 10 continues to receive the movement instruction above a certain degree after the object is stopped at the specific stop position, the CPU 11 sets the object to the focus condition again and continues (restarts) the movement of the object in accordance with the movement instruction. Thereby, the problem relating to the above deterioration of the convenience is avoided.

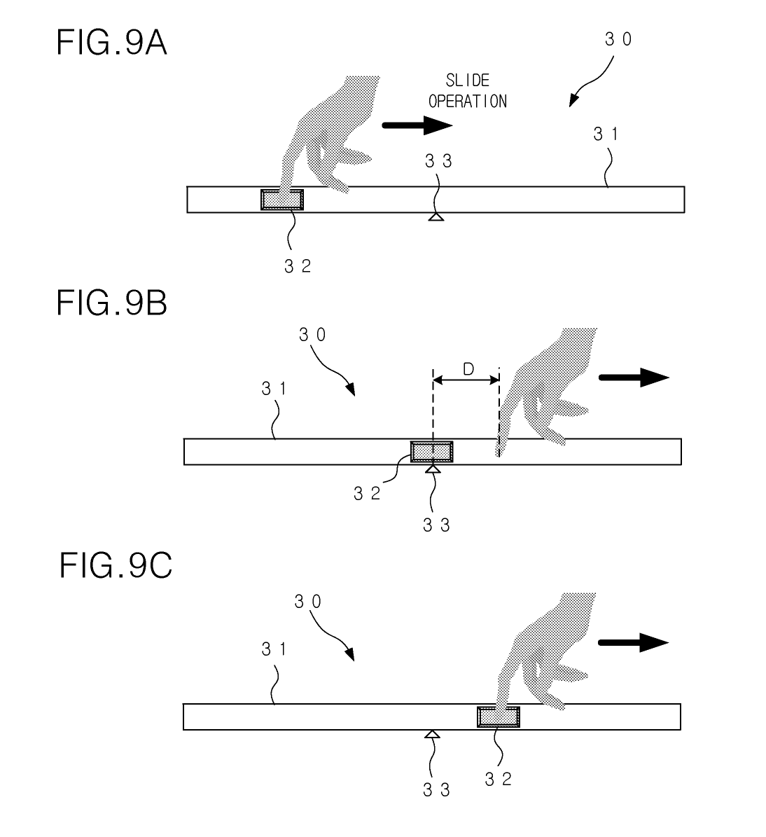

FIGS. 9A to 9C show the movement example in which the touch operation is continued by using the user's finger after the object (slider 32) is stopped at the specific stop position 33. After the touch position passes the specific stop position 33 and the object (slider 32) is stopped at the specific stop position 33, the touch operation is continued by using the user's finger. As shown in FIG. 9B, when the touch position is apart from the specific stop position 33 by the predetermined distance D, the CPU 11 sets the object (slider 32) to the focus condition again. Specifically, as shown in FIG. 9C, the object (slider 32) is moved and displayed at the touch position of the user's finger. Then, the CPU 11 moves the object (slider 32) so as to follow the touch position of the user's finger.

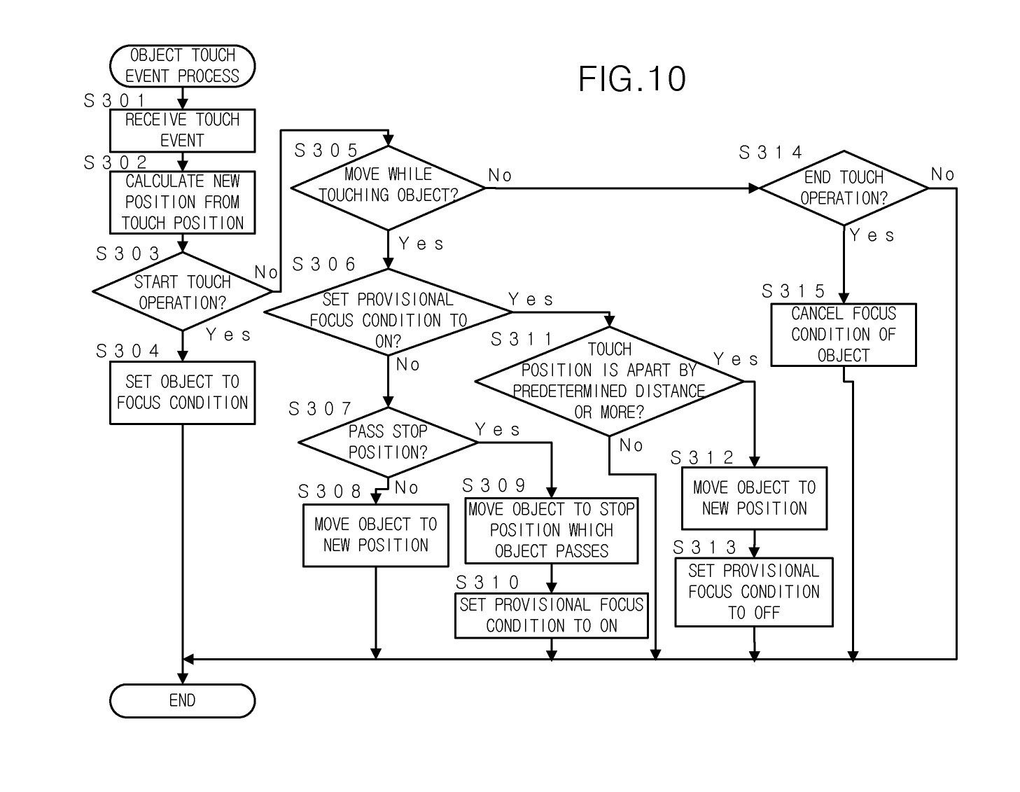

FIG. 10 shows the flowchart of the process which is carried out by the operation display device 10 according to the above movement of the touch position. The process is carried out every when any event is received via the touch panel 15a. When the event is received via the touch panel 15a (Step S301), the CPU 11 calculates a new touch position of the user's finger from the touch position indicated in the event (the touch position at the time of the generation of the event) (Step S302).

In case that the event which is received at present is the event in which the touch operation is started (Step S303; Yes), the CPU 11 sets the object to the focus condition (Step S304). Then, the process is ended. When the object is in the focus condition, the object receives the subsequent touch events.

In case that the event which is received at present is the event indicating that the user's finger moves while the finger touches the touch panel 15a (Step S305; Yes), the CPU 11 judges whether the provisional focus condition is set to ON (Step S306).

In case that the provisional focus condition is not set to ON (Step S306; No), the CPU 11 judges whether the touch position passes the specific stop position (Step S307). That is, the CPU 11 judges whether the specific stop position is positioned between the display position of the object and the new touch position.

In case that the object does not pass the specific stop position (Step S307; No), the CPU 11 moves the object to the new touch position to display the object at the new touch position (Step S308). Then, the process is ended. Thereby, the object is moved so as to follow the user's finger.

In case that the object passes the specific stop position (Step S307; Yes), the CPU 11 moves the display position of the object to the specific stop position which the object passes (Step S309). The CPU 11 sets the provisional focus condition to ON (Step S310). Then, the process is ended. Thereby, the object is stopped and displayed at the specific stop position and does not follow the user's finger.

In case that the provisional focus condition is set to ON (Step S306; No), the CPU 11 judges whether the distance between the specific stop position at which the object is stopped and the current touch position of the user's finger is equal to or more than the predetermined distance D (Step S311).

In case that the distance between the specific stop position at which the object is stopped and the current touch position of the user's finger is less than the predetermined distance D (Step S311; No), the process is ended. This situation is the situation in which the object is stopped at the specific stop position and only the user's finger moves while the user touches the touch panel 15a with the user's finger.

In case that the distance between the specific stop position at which the object is stopped and the current touch position of the user's finger is equal to or more than the predetermined distance D (Step S311; Yes), the CPU 11 moves the object to the current touch position of the user's finger to display the object at the current touch position (Step S312) and set the provisional focus condition to OFF (Step S313). Thereby, the object is moved again so as to follow the touch position of the user's finger.

In case that the event which is received at present is the event in which the touch operation is ended (the event indicating that the user's finger is released from the touch panel 15a) (Step S314; Yes), the CPU 11 cancels the focus condition of the object (Step S315). Then, the process is ended. Thereby, the object is stopped at the touch position shortly before the finger is released from the touch panel 15a.

Next, the setting of the specific stop position will be explained.

The specific stop position may be previously set on the side of the device. Alternatively, the specific stop position may be changed by being automatically set by the device according to any one of the operation conditions or the like, by being set to an optional position by the user, or the like.

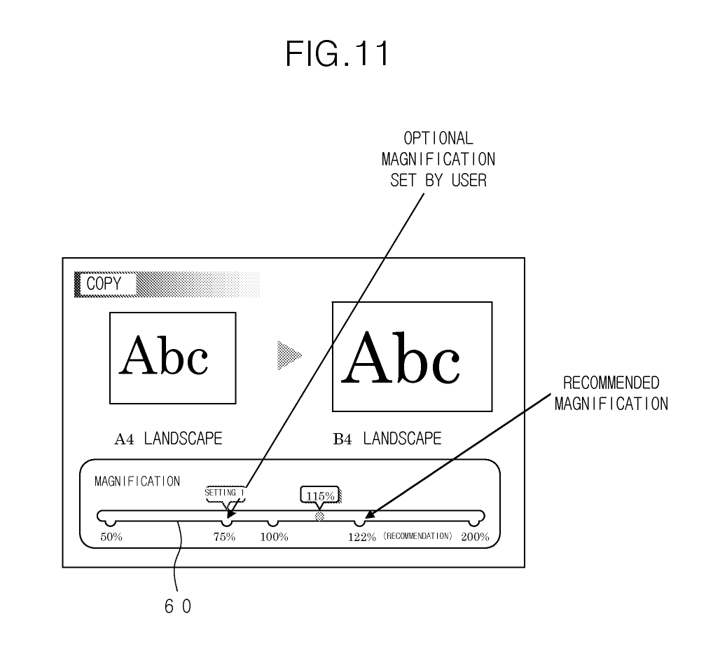

FIG. 11 shows an example of the slide bar 60 for setting the copy magnification of the multi-function peripheral. In this example, the specific stop positions are previously set to the positions corresponding to the minimum magnification (50%), the maximum magnification (200%) and the non-magnification (100%). In addition, the specific stop positions are added to the positions corresponding to the recommended magnification which is changed according to the combination of the original and the output sheet, and the optional magnification which is registered by the user.

As described above, in this embodiment, when the object is moved, the object can be precisely and easily stopped at the stop position which is previously set. Further, when the object approaches the stop position so as not to pass the stop position, the object can be stopped close to the stop position contrary to the snap function. Further, in case that the user continues to carry out the movement instruction after the object is stopped at the stop position, the movement of the object is restarted in accordance with the movement instruction. Therefore, even though many stop positions are set on the movement path, it is possible to easily move the object to the intended position.

As described above, the embodiment is explained by using the drawings. However, in the present invention, the concrete configuration is not limited to the above embodiment. In the present invention, various modifications of the above embodiments or the addition of various functions or the like to the embodiment can be carried out without departing from the gist of the invention.

For example, the type of the movement instruction (the operation method or the like) for moving the object is not limited to the instructions disclosed in the embodiment. Further, the movement instruction is not limited to the instruction to be received via the touch panel 15a. For example, the operation relating to the movement instruction using the key operation or a mouse which is a pointing device, may be received from the user.

For example, the operation for moving the object only while the movement instruction is received from the user is not limited to the touch operation shown in FIGS. 2A to 2C and FIG. 3. The above operation may be the drag operation which is carried out by using a mouse, the operation for moving the object only while the arrow key of the keyboard is pressed, or the like. Further, in this embodiment, the movement instruction for moving the object is carried out by directly contacting (touching) the contact body, such as the user's finger, with the touch panel 15a. However, in case that the movement instruction and the like is detected by using infrared light or the like, it is not necessary to directly contact (touch) the contact body with the operating unit. Therefore, in addition to the direct contact (touch) between the contact body and the operating unit, each of the term “contact” and the term “touch” includes the case in which the contact body is apart from the operating unit provided that the operating unit receives the movement instruction and the like.

Further, as an example in which the movement instruction is continued above a certain degree after the object is stopped, in the embodiment, in FIGS. 9A to 9C and FIG. 10, the case in which the touch position of the user's finger is apart from the specific stop position 33 by the predetermined distance D is exemplified. However, the example in which the movement instruction is continued above a certain degree after the object is stopped is not limited to the above case. For example, the case in which the movement instruction is continued above a certain degree after the object is stopped, may be the case in which the touch operation is continued during a certain time or more after the object is stopped at the specific stop position, or the like.

The object to be moved may be optional, and may be an enter box for entering a figure, a character or a text, or the like.

One of the objects of the above embodiment is to provide the object stop position control method, the operation display device, and the non-transitory computer-readable recording medium which can easily stop the object at the specific stop position, and can stop the object at an optional position including the position which is close to the specific stop position.

In the embodiment, when the object passes the predetermined stop position in the movement of the object in accordance with the movement instruction, the movement of the object, which is carried out in accordance with the movement instruction is stopped, and the object is stopped at the stop position.

In the embodiment, for example, only while the user touches the object with the user's finger to move the object, or only while the arrow key of the keyboard is pressed, the object is moved.

In the embodiment, in case that the user continues to carry out the movement instruction above a certain degree after the object is automatically stopped at the stop position, the object is moved again in accordance with the movement instruction.

In the embodiment, in case that the touch position passes the predetermined stop position, the object is automatically stopped at the predetermined stop position.

In the embodiment, in case that after the object is automatically stopped at the stop position, the user continues to carry out the touch operation until when the touch position is apart from the stop position by the predetermined distance or more, the object is moved again in accordance with the movement instruction.

In the embodiment, in the movement of the object, which is carried out in accordance with the movement instruction, the object is inertially moved. Then, also in case that the object passes the stop position when the object is inertially moved, the object is stopped at the stop position.

In the embodiment, it is possible to change the stop position at which the object is stopped when the object passes the stop position. The stop position is changed by being automatically set by the device or by being optionally set by the user.

According to the object stop position control method, the operation display device, and the non-transitory computer-readable recording medium, it is possible to easily stop the object at the specific stop position, and to stop the object close to the specific stop position.

The present U.S. patent application claims the priority of Japanese Patent Application No. 2014-000624 filed on Jan. 6, 2014, according to the Paris Convention, and the entirety of which is incorporated herein by reference for correction of incorrect translation.

What is claimed is:

1. An object stop position control method, comprising:
moving an object displayed on a display unit in accordance with a movement instruction for moving the object, in case that the movement instruction is received from a user; and
stopping a movement of the object, which is carried out in accordance with the movement instruction, to stop the object at a predetermined stop position, incase that it is judged that the object passes the predetermined stop position in the movement of the object.

2. The object stop position control method of claim 1, wherein in the movement of the object, which is carried out in accordance with the movement instruction, the obj ect is moved only while the movement instruction is received from the user.

3. The object stop position control method of claim 1, wherein in case that the movement instruction is continued above a certain degree after the object is stopped at the predetermined stop position, the movement of the object is restarted in accordance with the movement instruction.

4. The object stop position control method of claim 1, wherein a touch panel is provided on a display surface of the display unit,
the movement instruction is a touch operation in which after the touch panel is touched with a contact body at a display position of the object, a touch position of the contact body is moved while the touch panel is touched with the contact body,
in the movement of the object, which is carried out in accordance with the movement instruction, while the contact body touches the touch panel, the object is moved so as to follow the touch position of the contact body, and when the contact body is released from the touch panel, the object is stopped, and
in case that it is judged that the touch position of the contact body passes the predetermined stop position, the movement of the object, which is carried out in accordance with the movement instruction, is stopped to stop the object at the predetermined stop position.

5. The object stop position control method of claim 4, wherein in case that after the object is stopped at the predetermined position, the touch operation is continued and the touch position is apart from the predetermined stop position by a predetermined distance, the movement of the object is restarted in accordance with the movement instruction.

6. The object stop position control method of claim 1, wherein the movement instruction is an instruction for inertially moving the object after the movement instruction is ended, and
when the object which is inertially moved passes the predetermined stop position, the movement of the object, which is carried out in accordance with the movement instruction, is stopped to stop the object at the predetermined stop position.

7. The object stop position control method of claim 1, wherein a touch panel is provided on a display surface of the display unit,
the movement instruction is a flick operation in which after the touch panel is touched with a contact body at a display position of the object, the contact body is released from the touch panel so as to flick the object, and
in the movement of the object, which is carried out in accordance with the movement instruction, while the contact body touches the object, the object is moved so as to follow a touch position of the contact body, and after the contact body is released from the touch panel so as to flick the object, the object is inertially moved.

8. The object stop position control method of claim 1, wherein the predetermined stop position can be changed.

9. An operation display device, comprising:
a display unit;
a control unit configured to control a display of an object on the display unit; and
an operating unit configured to receive a movement instruction for moving the object displayed on the display unit, from a user,
wherein in case that the movement instruction is received from the user, the control unit moves the object in accordance with the movement instruction, and
in case that the control unit judges that the object passes a predetermined stop position in a movement of the object, which is carried out in accordance with the movement instruction, the control unit stops the movement of the object to stop the object at the predetermined stop position.

10. The operation display device of claim 9, wherein in the movement of the object, which is carried out in accordance with the movement instruction, the control unit moves the object only while the operating unit receives the movement instruction from the user.

11. The operation display device of claim 9, wherein in case that the movement instruction is continued above a certain degree after the object is stopped at the predetermined stop position, the control unit restarts the movement of the object in accordance with the movement instruction.

12. The operation display device of claim 9, wherein the operating unit comprises a touch panel, and the touch panel is provided on a display surface of the display unit,
the movement instruction is a touch operation in which after the touch panel is touched with a contact body at a display position of the object, a touch position of the contact body is moved while the touch panel is touched with the contact body,
in the movement of the object, which is carried out in accordance with the movement instruction, while the contact body touches the touch panel, the control unit moves the object so as to follow the touch position of the contact body, and when the contact body is released from the touch panel, the control unit stops the object, and
in case that the control unit judges that the touch position of the contact body passes the predetermined stop position, the control unit stops the movement of the object, which is carried out in accordance with the movement instruction, to stop the object at the predetermined stop position.

13. The operation display device of claim 12, wherein in case that after the object is stopped at the predetermined position, the touch operation is continued and the touch position is apart from the predetermined stop position by a predetermined distance, the control unit restarts the movement of the object in accordance with the movement instruction.

14. The operation display device of claim 9, wherein the movement instruction is an instruction for inertially moving the object after the movement instruction is ended, and
when the object which is inertially moved passes the predetermined stop position, the control unit stops the movement of the object, which is carried out in accordance with the movement instruction, to stop the object at the predetermined stop position.

15. The operation display device of claim 9, wherein the operating unit comprises a touch panel, and the touch panel is provided on a display surface of the display unit,
the movement instruction is a flick operation in which after the touch panel is touched with a contact body at a display position of the object, the contact body is released from the touch panel so as to flick the object, and
in the movement of the object, which is carried out in accordance with the movement instruction, while the contact body touches the object, the control unit moves the object so as to follow a touch position of the contact body, and after the contact body is released from the touch panel so as to flick the object, the control unit inertially moves the object.

16. The operation display device of claim 9, wherein the predetermined stop position can be changed.

17. A non-transitory computer-readable recording medium storing a program, wherein the program causes an information processing apparatus comprising a display unit having a display surface on which a touch panel is provided, to function as the operation display device of claim 9.
